(19) United States
(12) Patent Application Publication
(10) Pub. No.: US 2025/0022045 A1
(43) Pub. Date: Jan. 16, 2025

(54) PERSONAL PROPERTY SHARING SYSTEM

(71) Applicant: Charles Isgar, Scottsdale, AZ (US)

(72) Inventor: Charles Isgar, Scottsdale, AZ (US)

(21) Appl. No.: 18/901,883

(22) Filed: Sep. 30, 2024

Related U.S. Application Data
(63) Continuation of application No. 16/994,964, filed on Aug. 17, 2020, now abandoned.
(60) Provisional application No. 62/887,476, filed on Aug. 15, 2019.

(51) Int. Cl. G06Q 30/0645; G06Q 10/02; G06Q 30/0282; G06Q 30/0601

(52) U.S. Cl. CPC G06Q 30/0645; G06Q 10/02; G06Q 30/0282; G06Q 30/0639; G06Q 30/0643

(57) ABSTRACT

Described is a personal property sharing system for use between neighbors or others in like proximity. The system may include a server having a memory storing personal property information, a renter computing device coupled to the server, and a user computing device coupled to the server. The system operates to provide a means for a user to rent personal property from a renter for use on a particular date and for a particular duration on that date. This system uses modern technology to govern the lending, returning, and payment for utilization of property between neighbors or others in a like proximity of each other.

### CROSS REFERENCE TO RELATED APPLICATION

This application is a continuation of U.S. patent application entitled “PERSONAL PROPERTY SHARING SYSTEM,” Ser. No. 16/994,964, filed Aug. 17, 2020, which claims priority to U.S. Provisional patent application entitled “PERSONAL PROPERTY SHARING SYSTEM,” Ser. No. 62/887,476, filed Aug. 15, 2019, the disclosures of which are hereby incorporated entirely herein by reference.

### BACKGROUND OF THE INVENTION

### Technical Field

This invention generally relates to a system for sharing property, and more specifically to an organized system for sharing personal property with others within the same proximity, such as a neighborhood.

### State of the Art

There are several instances where an individual may have the need for certain items or spaces to use that the individual does not have. In such instances, some individuals have neighbors, friends or family from whom they can borrow the items. However, there are some that do not have neighbors, family or friends nearby or some whose neighbors, family and friends do not have the item. There is not a system that allows an individual to obtain use of an item from another or for a person to rent or lease certain items or other personal property to another for use.

Accordingly, what is needed is an organized system for sharing personal property within a defined proximity between one renting and a user allowing a user to rent the personal property for a set amount of time.

### SUMMARY OF THE INVENTION

An embodiment includes a personal property sharing system comprising: a server having a memory storing personal property information; a renter computing device coupled to the server; and a user computing device coupled to the server, wherein the server is programmed to: receive and process a signal that the user computing device has accessed the system and is searching for personal property to rent; send, for display, personal property information including available property to rent; receive and process a property request from the user computing device; automatically send the request for the personal property information to the renter computing device, including a selected date and duration of renting; receive and process a signal from the renter computing device, accepting the property request; and automatically reserve the requested property for the selected date and duration, in response to receiving the acceptance signal from the renter computing device.

The foregoing and other features and advantages of the invention will be apparent to those of ordinary skill in the art from the following more particular description of the invention and the accompanying drawings.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 is a diagrammatic view of a personal property sharing system according to an embodiment;

FIG. 2 is a user interface for interaction with a personal property sharing system according to an embodiment;

FIG. 3 is a user interface for interaction with a personal property sharing system according to an embodiment;

FIG. 4 is a user interface for interaction with a personal property sharing system according to an embodiment;

FIG. 5 depicts several items of personal property that may be available through a personal property sharing system according to an embodiment;

FIG. 6 is a user interface for interaction with a personal property sharing system for renting a parking space according to an embodiment;

FIG. 7 is a user interface for interaction with a personal property sharing system for requesting the renting of a parking space according to an embodiment; and

FIG. 8 is a user interface for interaction with a personal property sharing system for requesting the renting of a parking space according to an embodiment.

### DETAILED DESCRIPTION OF EMBODIMENTS OF THE INVENTION

Embodiments of the present invention relate to a personal property system for renting personal property from others using the system. The system is a formalized system that allows neighbors to share property, and the like, with each other and effect payment, lending and returning of items. It establishes an organized system with a set of rules of expectation of each party. Modern technology utilized by the system operates as a new and efficient bartering and borrowing system. The system may include the use of a mobile application operating on a user computing device and a renter computing device, either or both of which may be a mobile computing device like a smartphone, a tablet, a wearable, and the like; and/or the system may operate on any type of computing device as a downloadable application or even as a web application.

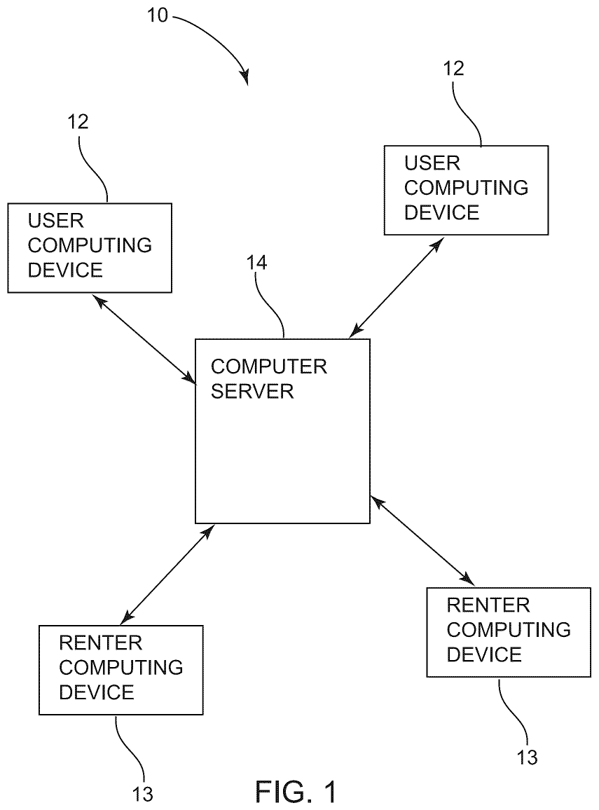

FIG. 1 depicts an embodiment of a personal property sharing system 10. The system 10 may include user computing devices 12, renter computing devices 13 and a server 14, wherein each user computing device 12 and renter computing device 13 is coupled to the computer server 14. This coupling may be a network connection, such as a wireless connection through an Internet connection, a Wi-Fi connection, a Bluetooth connection or the like, wherein the user computing devices 12 and renter computing devices 13 may communicate with and receive communication from the server 14. The user computing device 12 and/or the renter computing devices 13 may be any of a desktop computer, a laptop, a tablet, a smartphone, wearable devices and the like. The server 14, in some embodiments, may be a computer server or a cloud-based infrastructure architecture.

The server 14 may include a memory storing personal property information. The personal property information may include information of property available for rent, a photo of the property, location of the property, available dates and duration the property is available for rent, demographic information, contact information of the owner of the property, and the like.

A user computing device 12 and a renter computing device 13 may each be coupled to the server 14. The server 14 may be programmed to receive and process a signal that the user computing device has accessed the system and is searching for personal property to rent; send, for display, personal property information corresponding to an available property to rent; receive and process a property request, corresponding to the property, from the user computing device; automatically send the request for the personal property information to the renter computing device, wherein the property request includes a selected date and duration of renting; receive and process a signal from the renter computing device accepting the property request; and automatically reserve the requested property for the selected date and duration in response to receiving the acceptance signal from the renter computing device.

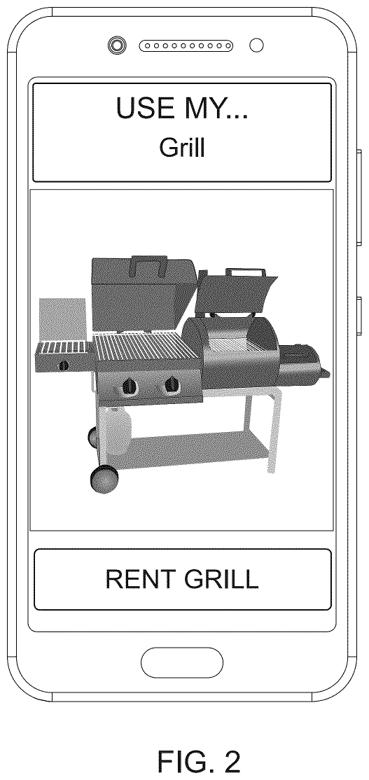

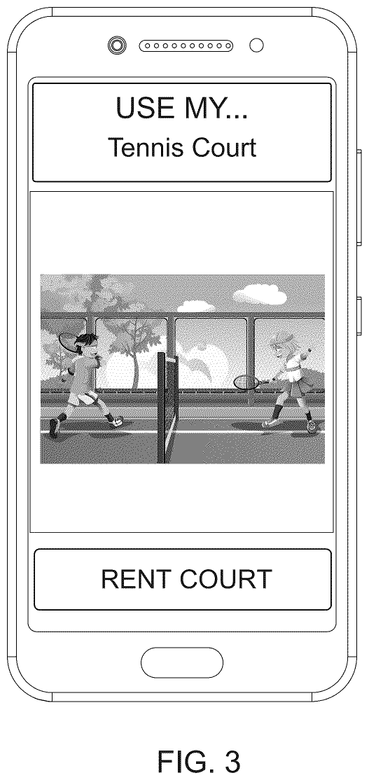

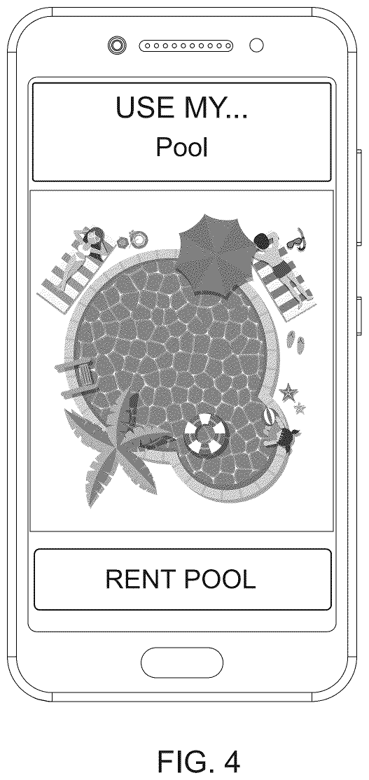

Referring to FIGS. 2-4, the system 10 may then allow a user to access the system through the user computing device. The mobile app operating on a smart phone may connect a user computing device with the server. The operation of the user computing device may include a user interface to see available property for rent. For example, FIG. 2 depicts a grill for rent; FIG. 3 depicts a tennis court for rent, and FIG. 4 depicts a pool for rent. As depicted in FIGS. 2-4, the user computing device may include a price and an ability to check the availability of the property. The user of the user computing device may select a link or button to check the availability and then may select a date and duration for requesting to rent the property. The renter computing device may then receive the request from the server and the renter of the property may have the ability to accept or deny the rental request. If the renter accepts the request, the personal property of the renter is reserved for the date and duration of the user's rental of the personal property.

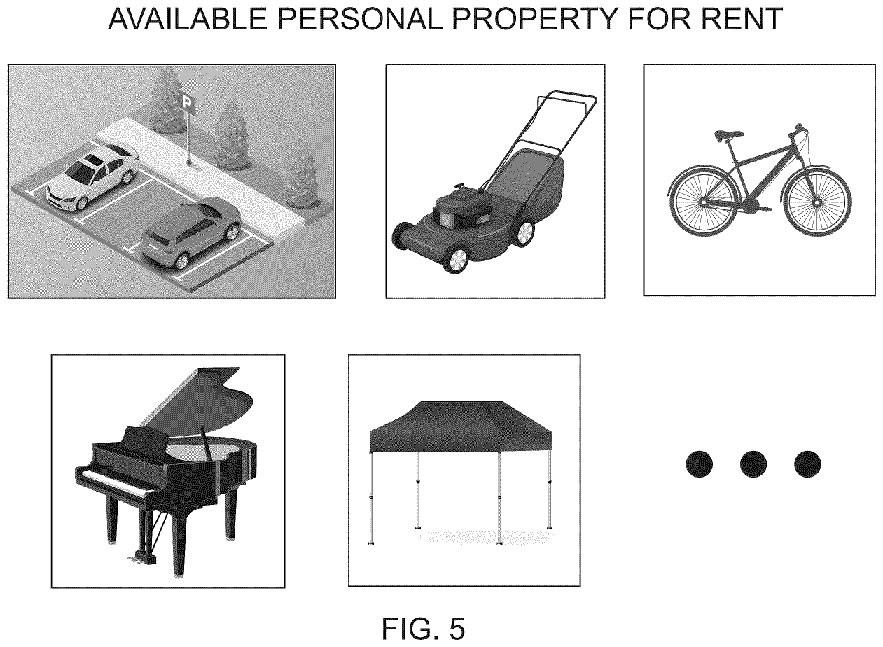

Referring to FIG. 5, the user may access any number of personal property items for rent. This may include a parking space, a lawnmower, a bicycle, a piano, a canopy, and more. This provides users, that do not have certain items, the ability to obtain use of such items as needed by the user without having to purchase the items. The system may allow the user to sort the items for rent by various filters, such as, location, cost, availability, renter information and the like.

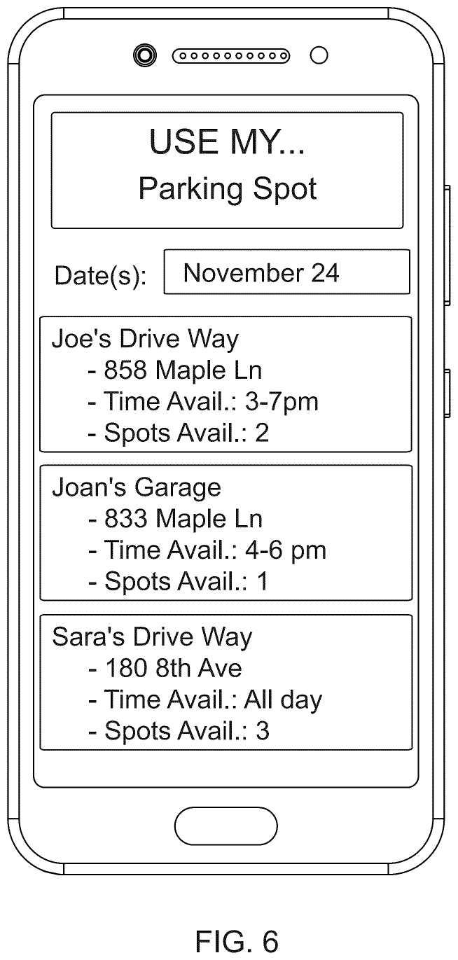

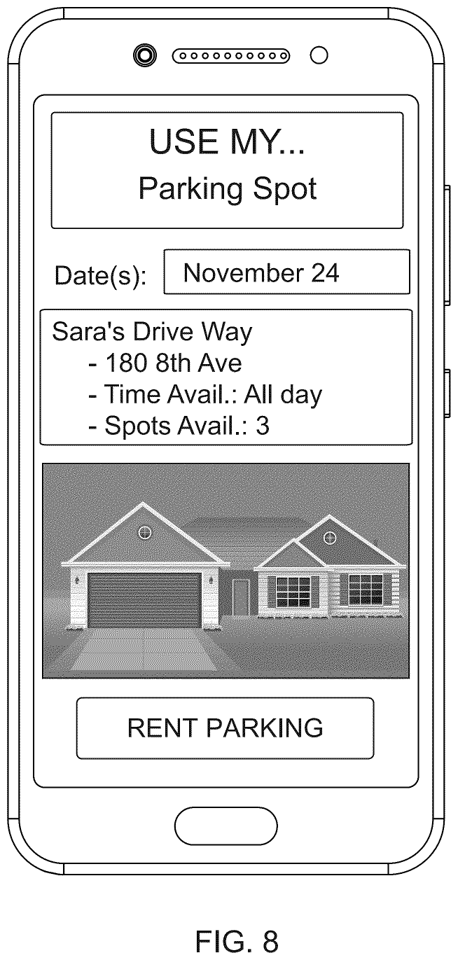

One particular useful aspect of embodiments of the system 10 is the use of the system for sharing and renting parking spaces. Accordingly, FIGS. 6-8 depict the embodiment and will be described as a non-limiting example, wherein other items of personal property may be rented in a similar manner. FIG. 6 depicts a user interface, wherein the user can search for parking spaces available near the user for a user-entered date. The server sends for display, on the user computing device, available parking spaces that include the location of the parking space(s), the time available at the searched date, and the parking spots available. A user can select one in order to request the spot. For example, a user may select “Sara's Drive Way” and will be directed to another user interface, as shown in FIG. 8. The user interface of FIG. 8 depicts that same information as described above along with an image of the parking space(s) available for rental. The user interface also includes a “Rent Parking” soft button. The selection of this button sends a request to the server to rent the parking spots. As described above, the request is forwarded to the renter, who may or may not accept the request. Upon acceptance, the system reserves the rental for the user.

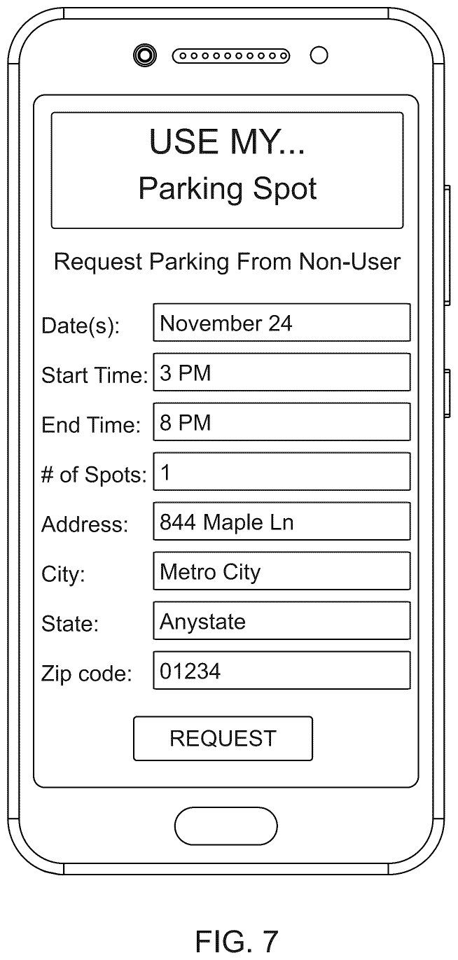

In some embodiments, the server may be coupled to a publicly-accessible directory of property addresses with corresponding owners of the properties located at those addresses and with contact information of those owners. Referring further to FIG. 7, a user may see a parking space that a user would like to rent, but the owner of the parking space is not a part of the system 10. In these instances, the system includes a user interface as depicted in FIG. 7, wherein a user may include dates, start time, end time, # of spots, address, city, state, zip code and the like. The user may then select a request button to send the request to the server. In response to the request sent by the user device, the server may automatically identify the owner of the parking space, by querying the directory, and send the owner a request to join the system and rent a parking space to the requester. The owner may then join the system and accept the request, thereby reserving the parking spot for the requestor for the dates and times requested.

It will be understood that the system 10 may include the ability to rate both the renter and the user. This information can persuade or dissuade a user and/or renter from engaging in a rental relationship with particular users or renters.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire-line, optical fiber cable, RF, etc., or any suitable combination of the foregoing.

Computer program code for carrying out operations for aspects of the present invention may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, cloud-based infrastructure architecture, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

1. A personal property sharing system comprising:
a server having a memory storing personal property information, wherein the server is coupled to a directory of property addresses with corresponding owners and contact information of the owners;
a renter computing device coupling to the server; and
a user smartphone operating a mobile app coupled to the server, wherein the server is programmed to:
receive and process a signal that the user smartphone, operating the mobile app, has accessed the system and is searching for personal property to rent, wherein the personal property is property that is temporary or moveable;
send, for display, the personal property information corresponding to available personal properties to rent, wherein a desired personal property to be rented is owned by an owner that has not accessed the system;
receive a request from the user smartphone through a user interface, wherein the request includes a date, a start time, and an end time for renting the desired personal property, and wherein a request button is selected by a user of the user smartphone to send the request to the server;
automatically identify the owner of the desired personal property, by querying the directory in response to the request sent by the user smartphone;
automatically send the owner a request to join the system and rent the desired personal property to the user of the user smartphone, wherein the request includes the date, the start time, and the end time for renting the desired personal property; and
reserve the desired personal property for the user in response to the owner joining the system through the renter computing device coupling to the server and accepting the request through the renter computing device.

2. The system of claim 1, wherein the personal property information includes information selected from the group consisting of a photo of the personal property, location of the personal property, dates the personal property is available, duration the personal property is available, contact information of an owner of the personal property, and any combination thereof.

3. The system of claim 1, wherein the server is further programmed to display a rating interface on the user computing device, wherein the user applies a rating to a renter corresponding to the renter computing device.

4. The system of claim 3, wherein the server is further programmed to store and aggregate a plurality of ratings associated with the renter, retrieve the ratings, and send the ratings for display on the user computing device.

5. The system of claim 1, wherein the server is further programmed to display a rating interface on the renter computing device, wherein a renter corresponding to the renter computing device applies a rating to a user of the user computing device.

6. The system of claim 5, wherein the server is further programmed to store and aggregate a plurality of ratings associated with the user, retrieve the ratings, and send the ratings for display on the renter computing device.

7. The system of claim 1, wherein the personal property is selected from the group consisting of a grill, a lawnmower, a bicycle, a piano, and/or a canopy.
